(19) United States
(12) Patent Application Publication
(10) Pub. No.: US 2003/0049178 A1
(43) Pub. Date: Mar. 13, 2003

(54) Apparatus for imprinting cassettes and/or speciman slides for histological preparations in a printing system

(76) Inventors: Uwe Kiene, Eppelheim (DE); Andreas Laudat, Meckesheim (DE); Holger Metzner, Nussloch (DE); Roland Walter, Neulussheim (DE)

Correspondence Address: George L. Snyder, Jr., Hodgson Russ LLP, Suite 2000, One M&T Plaza, Buffalo, NY, 14203-2391, US

(21) Appl. No.: 10/206,526

(22) Filed: Jul. 26, 2002

(30) Foreign Application Priority Data
Sep. 6, 2001 (DE) 101 43 803.6

(51) Int. Cl. B01L 3/02

(52) U.S. Cl. 422/100; 436/180; 436/54

(57) ABSTRACT

An apparatus for imprinting cassettes (1) and/or specimen slides, having a printing head (2) and a delivery device (3) for the cassettes (1) and/or specimen slides, is described. A pivot device (5) is provided for alignment of the printing head (2) with differently inclined printing planes (4) or for alignment of differently inclined printing planes (4) with the printing head (2).

### CROSS REFERENCE TO RELATED APPLICATIONS

This application claims priority of the German patent application 101 43 803.6 filed Sep. 6, 2001 which is incorporated by reference herein.

### FIELD OF THE INVENTION

The invention concerns an improvement in an apparatus for imprinting cassettes and/or specimen slides carrying histological preparations, where the apparatus is of a type having a printing head and a delivery device for the cassettes and/or specimen slides.

### BACKGROUND OF THE INVENTION

GB 2 235 163 A discloses a plotter for plastic cassettes in which labeling is accomplished via a thermal method using a heatable plotter pin and a carbon ribbon. Here the plastic cassettes are arranged in a stack magazine and can be delivered individually to the printer via a detent pawl. A further exemplary embodiment shows a stack magazine, having a stack of glass specimen slides, in which the specimen slides can be removed individually. A disadvantage here is that only a single stack magazine is provided in the printer, and the printer can imprint only plastic cassettes or only specimen slides. Selectable imprinting of cassettes and/or specimen slides is not possible.

An “engraving machine” for a specimen slide and/or cassette is known from GB 2 206 083. This engraving device is controlled via a computer and an interface, and allows appropriate markings to be scribed into the cassette or the specimen slide. It is disadvantageous, however, that this machine works very loudly and very slowly, and also produces a great deal of debris from the engraving. The engraved code is also very difficult to read.

A printing system for imprinting cassettes and/or specimen slides for histological preparations is known from previously unpublished DE 101 15 065, which corresponds to commonly owned U.S. patent application Ser. No. 10/106159 filed Mar. 26, 2002. The system depicted and described therein comprises a material delivery device having multiple stack magazines, as well as a printing device and a drying device. The stack magazines are configured to receive cassettes arranged one above another and/or glass specimen slides. A cassette stack that can be introduced into the stack magazine is depicted and described, for example, in DE 201 04 158, which corresponds to commonly owned U.S. patent application Ser. No. 10/093312 filed Mar. 7, 2002.

The printing system depicted and described in DE 101 15 065 has proven successful because it comprises multiple individually loadable stack magazines. As a result, both cassettes and specimen slides can be stockpiled simultaneously and delivered selectably to the printing device. The plane to be imprinted on the cassettes, however, is located at a different angle with respect to the printing head than the plane to be imprinted on the specimen slides. In addition, the printing plane on the cassettes can vary. The angle of inclination on the various cassettes can fluctuate between 35° and 45° from the horizontal.

### SUMMARY OF THE INVENTION

It is the object of the present invention to create an apparatus that can selectably imprint the widest variety of cassettes and/or specimen slides.

According to the present invention, this object is achieved in an apparatus for imprinting cassettes and/or specimen slides by way of an improvement comprising a pivot device for alignment of a printing head of the apparatus with differently inclined printing planes or for alignment of differently inclined printing planes with the printing head. Advantageous developments of the invention are described herein.

The apparatus for imprinting cassettes and/or specimen slides is characterized in that a device for delivering the cassettes and/or specimen slides to the printing head is present; and for alignment with differently inclined printing planes, the printing head is mounted rotatably via a pivot device. As a result, printing planes of any inclination can be occupied by the printing head, and individual printing onto the plastic cassette with its inclined printing planes, or the planar printing plane of the specimen slide, can be accomplished. Provision can of course also be made, in order to align the variously inclined printing planes with the printing head, for providing a pivot device for the plastic cassettes and the specimen slides, so that the latter can be aligned by way of the pivot device with a printing head arranged in stationary fashion.

In a further embodiment of the invention, provision is made for configuring the pivot device with a rotatable drum that can be rotated over a large pivot range exceeding 180°.

In a preferred embodiment, the printing head is arranged on the drum.

In a further embodiment of the invention, the pivot device is movable into any desired rotational positions, the pivot device being equipped with an incremental transducer for unequivocal identification of the rotational position.

For imprinting of the cassettes and/or specimen slides, the printing head is configured to be displaceable via the pivot device into various printing positions.

It has proven to be advantageous if the printing head is configured to be displaceable via the pivot device into a cleaning position and/or a parked position.

In a further embodiment, for multi-line printing provision is made for arranging in the apparatus a movable printing carriage that is configured to be movable perpendicular to the printing direction.

It has proven advantageous if the printing carriage is associated with the printing head.

In a further embodiment of the invention, the cassette or specimen slide to be imprinted is arranged on a displaceable specimen carriage.

In a further embodiment, the specimen carriage is embodied movably parallel to the printing head for printing.

In a further embodiment of the invention, the printing head is embodied as an inkjet printing head and comprises multiple nozzles arranged next to one another. In order to achieve a higher printing resolution, the printing head is arranged with its row of nozzles obliquely with respect to the printing direction.

In a further embodiment of the invention, a vacuum system that aspirates ink through the ink nozzles in order to clean the printing head is arranged in the cleaning position and/or parked position.

In an advantageous embodiment of the invention, a seal for airtight closure of the printing head is arranged in the parked position of the printing head.

In a development of the invention, a mount for a sponge is arranged on the specimen carriage, and the sponge is impregnated with a solvent for the ink being used.

It has proven advantageous in this context if, for intensive cleaning, the printing head is moved past the sponge several times.

In a further embodiment of the invention, by means of the specimen carriage the printing head can also be movable directly onto the sponge and can remain there for a certain time in order to loosen dried ink. A combination of the two actions has proven particularly effective for intensive cleaning of the printing head.

### BRIEF DESCRIPTION OF THE DRAWINGS

The invention will be depicted and explained further in an exemplary embodiment with reference to the schematic drawings, in which:

FIG. 1 is a view of the printing apparatus with the printing head and two cassettes in the delivery device;

FIG. 2 is a view of the printing head in a printing position;

FIG. 3 is a view of the printing head in a parked position;

FIG. 4 is a view of the apparatus with the printing carriage and drive motor.

### DETAILED DESCRIPTION OF THE INVENTION

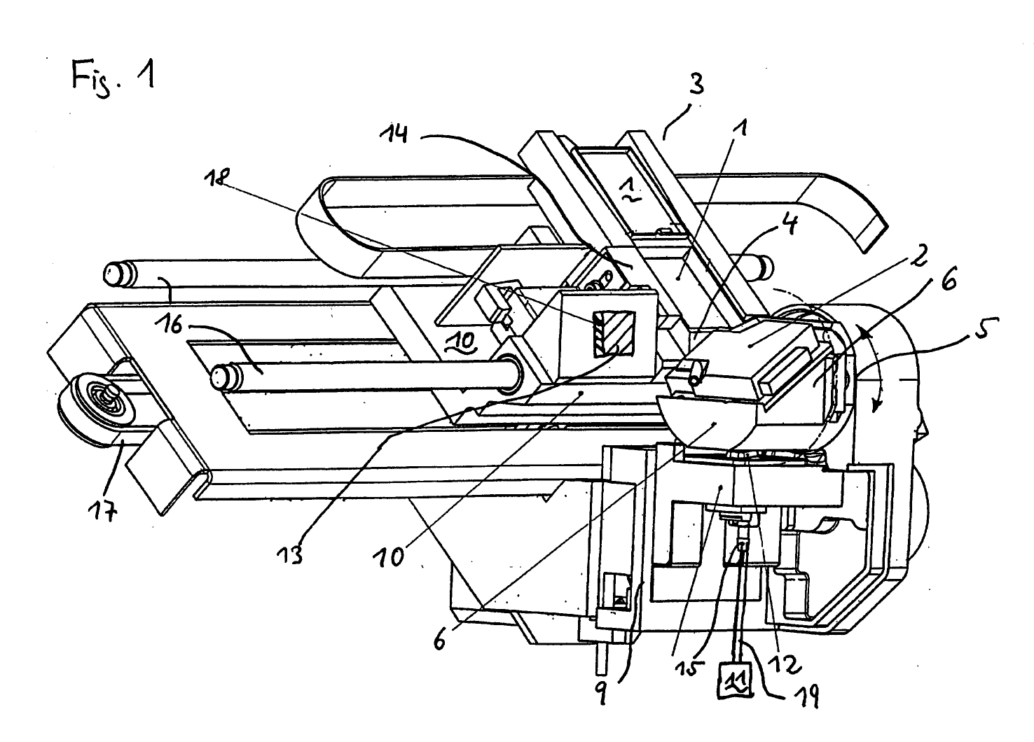

FIG. 1 shows an apparatus for imprinting cassettes 1, having a printing head 2 that is mounted rotatably by way of a pivot device 5. Pivot device 5 comprises a drum 6 to which printing head 2 is attached. Cassette 1 with a printing plane 4 is arranged opposite printing head 2 in a holding clamp 14 of a delivery device 3. Delivery device 3 with holding clamp 14 is arranged on a specimen carriage 10 displaceably with a guide rod assembly 16 and a toothed drive belt 17. For printing, specimen carriage 10 is displaced laterally so that printing plane 4 on cassette 1 is moved parallel to printing head 2. Arranged on specimen carriage 10 in a mount 18 is a sponge 13 that is impregnated with a solvent for the printing medium, preferably ink. Sponge 13 can be moved past printing head 2 by means of specimen carriage 10. It has proven advantageous in this context if, for intensive cleaning, printing head 2 is moved past sponge 13 several times. Printing head 2 can also be displaced by way of specimen carriage 10 directly onto sponge 13, and remain there for a certain time in order to loosen dried ink. For intensive cleaning of the printing head, a combination of the two actions has proven particularly effective.

Printing head 2 is arranged, together with pivot device 5, on a printing carriage 9, and is configured to be movable by way of printing specimen carriage 9 perpendicular to the movement direction of specimen carriage 10. Multi-line imprinting of cassette 1 and/or the specimen slide can thereby be implemented. Printing carriage 9 furthermore comprises a seal 12 for airtight closure of printing head 2. Printing head 2 is displaced onto seal 12 by means of pivot device 5. Printing carriage 9 additionally comprises a connector fitting 15 having a connector line 19 for a downstream vacuum system 11 with which ink is aspirated through the printing nozzles in order to clean printing head 2.

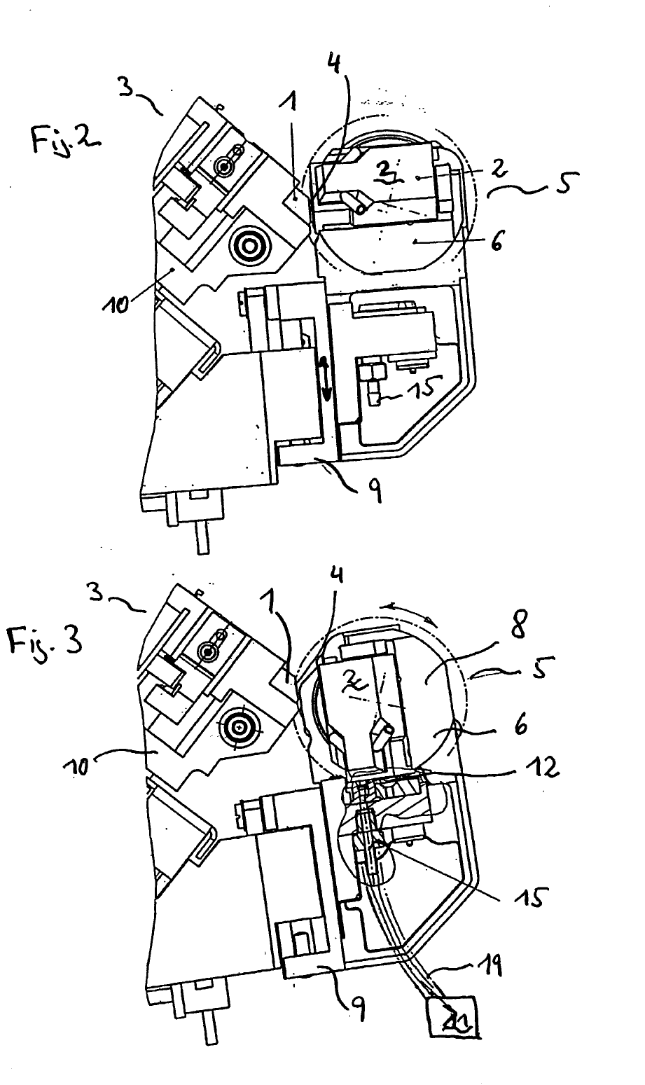

FIG. 2 is a side view of the apparatus with cassette 1 and printing head 2, which is held in the printing position by pivot device 5 and drum 6. By way of pivot device 5, printing head 2 can occupy a variety of printing planes 4 in order to achieve optimum adaptation to differently inclined imprinting fields or printing planes 4 on cassettes 1. By way of printing carriage 9, printing head 2 is embodied displaceably in printing plane 4 in the double-arrow direction for multi-line printing.

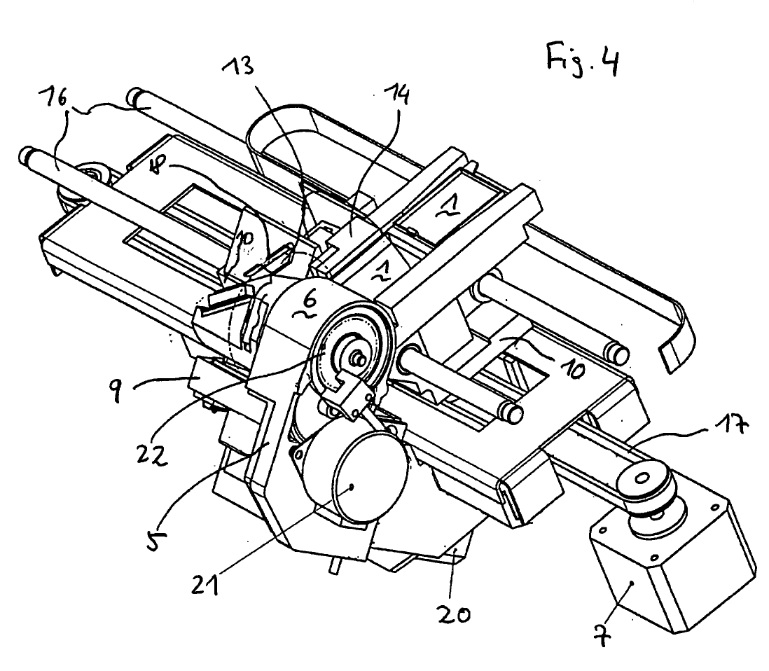

FIG. 3 is a side view of the apparatus, printing head 2 having in this case been brought by pivot device 5 into a parked position 8. The printing nozzles of printing head 2 are closed off in airtight fashion by seal 12. Ink can now be aspirated through printing head 2 by way of vacuum system 11 and connector line 19. Cleaning of printing head 2 and its nozzles is thereby achieved.

FIG. 4 is a view of the printing device with a drive motor 7 for specimen carriage 10. Pivot device 5 comprises a motor 21 and an incremental transducer 22 for accurate positioning of printing head 2 via drum 6. A motor 20 is provided to drive printing carriage 9.

The invention is of course not limited to inkjet printing heads; instead, any desired device can be used for labeling. The subject matter of the invention can advantageously be utilized whenever it is necessary for differently inclined printing planes to be traveled to.

| | PARTS LIST |
|---|---|
| 1 | Cassette |
| 2 | Printing head |
| 3 | Delivery device |
| 4 | Printing plane |
| 5 | Pivot device |
| 6 | Drum |
| 7 | Motor for 10 |
| 8 | Parked position |
| 9 | Printing carriage |
| 10 | Specimen carriage |
| 11 | Vacuum system |
| 12 | Seal |
| 13 | Sponge |
| 14 | Holding clamps |
| 15 | Connector fitting |
| 16 | Guide rod assembly |
| 17 | Toothed drive belt |
| 18 | Mount for 13 |
| 19 | Connector line |
| 20 | Motor for 9 |
| 21 | Motor for 5 |
| 22 | Incremental transducer |

What is claimed is:

1. An improvement in an apparatus for imprinting cassettes (1) and/or specimen slides, the apparatus having a printing head (2) and a delivery device (3) for the cassettes (1) and/or specimen slides,
wherein the improvement comprises a pivot device (5) for alignment of the printing head (2) with differently inclined printing planes (4) or for alignment of differently inclined printing planes (4) with the printing head (2).

2. The improvement as defined in claim 1, wherein the pivot device (5) comprises a rotatable drum (6).

3. The improvement as defined in claim 1, wherein the printing head (2) is arranged on the pivot device (5).

4. The improvement as defined in claim 3, wherein the pivot device (5) is movable into any desired rotational positions.

5. The improvement as defined in claim 4, wherein the printing head (2) is displaceable via the pivot device (5) into various printing positions.

6. The improvement as defined in claim 4, wherein the printing head (2) is displaceable via the pivot device (5) into a cleaning position and/or a parked position (8).

7. The improvement as defined in claim 1, further comprising a movable printing carriage (9) for multi-line printing.

8. The improvement as defined in claim 7, wherein the printing carriage (9) is associated with the printing head (2).

9. The improvement as defined in claim 1, further comprising a displaceable specimen carriage (10), wherein the cassette (1) or specimen slide to be imprinted is arranged on the displaceable specimen carriage (10).

10. The improvement as defined in claim 9, wherein the specimen carriage (10) is movable parallel to the printing head (2) for printing.

11. The improvement as defined in claim 6, wherein the printing head (2) comprises multiple nozzles arranged next to one another; and in order to achieve a higher printing resolution, the printing head (2) is arranged obliquely with respect to a printing direction.

12. The improvement as defined in claim 11, further comprising a vacuum system (11) that aspirates ink through the ink nozzles when the printing head (2) is in its cleaning position and/or parked position (8).

13. The improvement as defined in claim 6, further comprising a seal (12) for airtight closure of the printing head (2) when the printing head is in its parked position (8).

14. The improvement as defined in claim 9, further comprising a sponge (13) arranged on the specimen carriage (10), and the sponge (13) has a solvent for ink imprinted by the apparatus.

15. The improvement as defined in claim 14, wherein for intensive cleaning of the printing head (2), the sponge (13) is moved past the printing head (2) several times.

16. The improvement as defined in claim 14, wherein for intensive cleaning, the sponge (13) is movable via the specimen carriage (10) in front of the printing head (2).

17. The improvement as defined in claim 14, further comprising a movable printing carriage (9), wherein for intensive cleaning, the printing head (2) is movable via the printing carriage (9) onto the sponge (13).
